(19) United States
(12) Patent Application Publication
(10) Pub. No.: US 2024/0283314 A1
(43) Pub. Date: Aug. 22, 2024

(54) AXIAL RADIAL FLUX MOTOR COMBINATION WITH AXIAL WINDINGS

(71) Applicant: John Robert Culleton, III, Cibolo, TX (US)

(72) Inventor: John Robert Culleton, III, Cibolo, TX (US)

(21) Appl. No.: 18/587,811

(22) Filed: Feb. 26, 2024

Related U.S. Application Data
(63) Continuation-in-part of application No. 16/417,990, filed on May 21, 2019, now Pat. No. 11,942,824.

(51) Int. Cl. H02K 3/24; H02K 1/2753; H02K 3/28; H02K 16/00

(52) U.S. Cl. CPC H02K 3/24; H02K 1/2753; H02K 3/28; H02K 16/00; H02K 2201/03

(57) ABSTRACT

An axial flux electrical machine, such as an electric motor, dynamo, pump, generator, or alternator has a casing with vents or openings enabling cooling or pumped media to flow into and out of the casing when the rotor of the electrical machine rotates. The stator is formed from conductive elements connected at their axial outer regions by interconnecting members. Conductive elements have a gap or space to direct cooling through the winding to the central region. Each conductive element has legs bent in opposing directions relative to the starting plane of the conductor closest to the central axis then the second leg is bent back in the direction of the first. A portion of the windings of the stator are spaced apart to allow media to flow between the windings to the central axis area and then is allowed flow outward between the rotor and the stator.

### CROSS-REFERENCE TO RELATED APPLICATIONS

This application is a continuation-in-part of U.S. Nonprovisional patent application Ser. No. 16/417,990; Filed: May 21, 2019, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE

Not applicable

### SEQUENCE LISTING

Not applicable

### FIELD OF THE INVENTION

The present invention is an improvement to current axial flux machines, better known as pancake motors, generators, or pumps with self-pumping action for cooling media, or other media through the internal bodies of the machine and a method of assembly.

### BACKGROUND OF THE INVENTION

Without limiting the scope of the disclosed device and methods, the background is described in connection with novel devices and methods of use for axial radial flux motors.

Axial flux machines are known for their high-powered capabilities in flat or compact packages. A downside to this compact design is high power requires high current which creates substantial amounts of heat that cannot be easily dissipated. Overheating in these machines can lead to the failure of magnets, wire insulation, and electrical connections.

Axial flux machines generally use an open frame for cooling low to medium power machines, which is inadequate for machines of more than two rotors as most of the coolant media is often brought in axially. On machines where coolant is brought in radially it is often required to be under pressure or have channels through the rotor which weakens them.

Higher power axial flux Machines are often fed coolant under pressure as the natural rotation of the machines rotors tends to resist coolant being introduced between rotors and stators and energy is wasted driving a pump required to overcome rotors tendency to force coolant outward when spinning.

Axial flux machines are hard to assemble in configurations of more than two rotors due to the electrical connections between rotor and/or stator elements and extreme magnetic forces involved.

Coolant entering axially from the ends of the machine make it difficult to cool inner rotor and/or stator element(s) on multiple element arrangements without placing holes in the rotor(s), or using a hollow shaft with holes, or other method that weaken the overall integrity of the motor.

Many machines have interconnections and electrical joints that require care in assembly and are potential points of failure due to fatigue or overheating, often requiring complete disassembly to repair. The number of interconnections multiplies by the number of rotors, increasing the chances of a failure, and cumulatively increasing resistance with each interconnection, reducing efficiency.

Axial flux machines often have rotating phase windings with stationary flux generators (magnetic sources) that often make the rotating windings physically vulnerable to sudden shocks and jolts causing the windings to flex or disassemble especially where joints or connections cross over/under the rotor centerline.

Some machine designs allow for rotating magnetic sources but again are usually limited to 2 rotors and a large diameter because it is difficult to manage the powerful magnet plates and windings during assembly.

Disassembly of a conventional axial flux motor is often difficult, dangerous, or impractical due to the large magnetic forces involved that often leads to damage or destruction of the machine's major components, making cost of repair unreasonable.

Some axial flux machines are assembled with permanent magnets that are not magnetized and are magnetized after the structure is complete making another construction step requiring up to thousands of amps being sent through a sacrificial conductor inside the case. Present axial flux machines that contain more than 2 rotors are often multiple separate machines bolted together in a special fixture causing control, connection, and mounting issues with the additional mounting hardware, frame(s), and control connection(s) increasing weight, size, and complexity due to the increased number of bearings, endplates, structural supports, and electrical connections.

Axial flux machines often have the commutated portions of windings(such as those in a printed disc motor or lynch motor) that lean or are in opposite directions making placement of a flux enhancing material, such as ferrite or silicon steel or other suitable material, that passes through the windings difficult or impossible. Axial flux machines often have a large diameter to get the needed torque and thus have lower RPM ranges.

### BRIEF SUMMARY OF THE INVENTION

An axial flux machine that overcomes the common limitations previous machines by increasing number of rotor and/or stator members providing cooling/media path(s) through the central body of the stator and/or the rotor.

Depending on configuration, as an out-runner (case rotates, axis stationary) or an in-runner (case stationary, axis rotates), a plurality of rotors, (hereafter describing an in-runner with windings placed as an outer stator although placing the windings on the central axis is similar in concept except the coolant would have to flow between magnetic sources vice windings first), and stator segments have quasi-independent, (a media path per rotor or rotor surface), coolant media or pumping media path, (hereafter called coolant), allowing a plurality of rotor(s) to share a common central axis shaft thus being compact and efficient without complex internal interconnected coolant circuits and a multitude of electrical connections.

An advantage of the winding design and coolant path in the present invention is a plurality of rotors allowing for great torque while maintaining a higher RPM range than previous designs that specifically use two or less large rotors.

The coolant or media would travel at least once from the periphery into the machine towards and near to the central axis providing cooling to the windings internally, and then pass from the windings into the area between the stationary portion and the rotating portion allowing coolant to flow and be drawn outwards towards the periphery cooling both the rotor and stator before exiting the internal portion of the windings.

Another object of this patent is to create a machine with stator and rotor arrangements that overcome negative issues in prior art and allow a continuous conductor for each winding section to be placed between multiple rotors depending on configuration and allow assembly with minimal electrical connections or joints.

With no joints or electrical connections needing to cross over, (or under depending on configuration), a rotor simply adding rotors and/or stators to the machine's design will not necessarily increase the number of electrical joints or connections thereby reducing overall resistance and failure points.

These and other objects of this patent are a machine with stator and rotor arrangements that reduce weight, allow for an increased number of rotors or stators (depending on configuration) to be assembled on a common central axis and, unlike previous methods of stacking complete motors with endplates and/or bearings on the same shaft, provide better internal media flow for cooling, or pumping, as well as a single location for input or commutation and a continuous flux path axially from end to end without the need for intermediate flux back iron, or flux termination plates, and/or bearings that multiple motors assembled together require.

Structural integrity is greater by placing the windings in the stator so that sudden jolts or shocks to the rotating members have little effect on windings structure and electrical connections especially since all electrical connections and winding interconnections are at the extreme ends of the central axis.

Another benefit of having electrical connections and winding segment interconnections at the axial ends of the machine is easy access for connections and/or repair or winding reconfiguration. Another advantage of this design allows powerful magnets or electromagnets to be placed in or on a rotor, or stator, (depending on configuration), and the rotor(s)/stator(s) to be assembled using periphery cooling both the rotor and stator before exiting the internal portion of the windings.

Another object of this patent is to create a machine with stator and rotor arrangements that overcome negative issues in prior art and allow a continuous conductor for each winding section to be placed between multiple rotors depending on configuration and allow assembly with minimal electrical connections or joints.

With no joints or electrical connections needing to cross over, (or under depending on configuration), a rotor simply adding rotors and/or stators to the machine's design will not necessarily increase the number of electrical joints or connections thereby reducing overall resistance and failure points.

These and other objects of this patent are a machine with stator and rotor arrangements that reduce weight, allow for an increased number of rotors or stators (depending on configuration) to be assembled on a common central axis and, unlike previous methods of stacking complete motors with endplates and/or bearings on the same shaft, provide better internal media flow for cooling, or pumping, as well as a single location for input or commutation and a continuous flux path axially from end to end without the need for intermediate flux back iron, or flux termination plates, and/or bearings that multiple motors assembled together require.

Structural integrity is greater by placing the windings in the stator so that sudden jolts or shocks to the rotating members have little effect on windings structure and electrical connections especially since all electrical connections and winding interconnections are at the extreme ends of the central axis.

Another benefit of having electrical connections and winding segment interconnections at the axial ends of the machine is easy access for connections and/or repair or winding reconfiguration. Another advantage of this design allows powerful magnets or electromagnets to be placed in or on a rotor, or stator, (depending on configuration), and the rotor(s)/stator(s) to be assembled using magnetized permanent magnets, Halbach arrays, or electromagnets or any combination thereof without the rest of the assembly in the way. The windings could then be placed around and/or between the fully powered magnets without danger of case parts or rotors slamming together or of damage to the windings. Any bridging between conductive elements would be minimal and generally at either end of the machine or would not require complete disassembly of the machine to effect repairs.

The present design would allow ferrite or flux enhancing material such as silicon steel to be easily placed between windings during assembly and allow both axial ends of said flux enhancing material piece to be exposed to the rotors magnetic flux parallel and flush with the individual winding segments.

These and other objects of the invention are attained by providing a path for coolant or other media path through the interior of the machine accompanied by the use of composites or other lightweight mostly nonferrous and/or nonconductive support materials used in either the rotor(s) and stator(s) or any combination thereof with rotor(s) and stator(s) placed in close proximity of each other's face and directly in the flux path to assist or generate movement of said coolant or other media from the outer periphery of one element through that element to flow near the center axis and then flow between stator and rotor element(s) or by pumping media between elements towards the central axis and then through element(s) back towards the periphery while limiting the number of necessary electrical joints or connections by using continuous conductors axially through the machine.

Further this machine could have the windings placed on the central axis (rotating or stationary styles) and still have the benefit of continuous winding segments without extra interconnections by inverting the leg arrangement used for the stator's windings. Further improvements can be attained by staggering the segment portions on both the inner plane and outer plane to increase coolant or pumped media flow.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a typical rotor arrangement with rotor mounted flux termination rings;

FIG. 2 are typical windings with stabilizer rings and interconnects;

FIG. 3 are typical windings with media gap and leg portions;

FIG. 4 are typical windings as in FIG. 3 with bends shown in flat view for standard rotors;

FIG. 5 are typical windings as in FIG. 4 perspective view with flux generators (permanent magnets);

FIG. 6 are typical windings as in FIG. 3 from end view or axial view;

FIG. 7 is a view of typical interleaved windings with cores (flux enhancers) and epoxy;

FIG. 8 is an axial end view of a motor with interconnects and phase connections depicting a typical 3 phase arrangement;

FIG. 9 is a perspective view of a motor case with typical inlet and outlet openings;

FIG. 10 is an alternate side or radial view of 9;

FIG. 11 is a cross section view showing coolant or media path through a segment portion;

FIG. 12 is a typical winding for use with halbach array rotors; and

FIG. 13 is a typical winding with two interconnected segments.

### DETAILED DESCRIPTION OF THE INVENTION

Disclosed herein are novel devices and methods of use for axial radial flux motors

In brief, the invention is directed to devices and methods of use for axial radial flux motors.

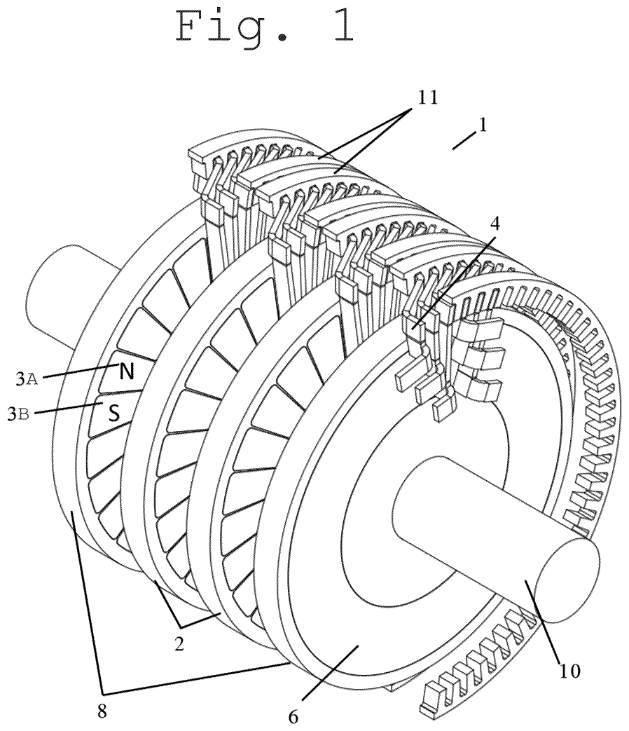

An ideal embodiment FIG. 1 of the present invention an axial flux machine 1 typically used as a generator, motor, or pump that has a central axis with a shaft 10 and a plurality of inner rotors 2 in this embodiment numbering 2 arranged on said shaft with circumferentially disposed magnetic flux generators such as electromagnets or permanent magnets 3A, 3B, in this case 24 per permanent magnets per said inner rotor(s) with opposing adjacent sides of said rotor alternating in polarity 3A,3B in a standard configuration. Outer rotors 8 have flux terminators 6 attached to them preferably out of some soft ferromagnetic material to complete the axial flux magnetic path in the case of standard magnetic fields.

Circumferentially dispersed around said rotors is a plurality of conductive windings 4 with a typical winding segment having a continuous conductor with joints or connections taking place beyond outer rotors 8 usually near the flux termination ring but not in the direct flux path generated by flux generators affixed to said rotors.

A plurality of winding spacer(s) example 11 may be used to stabilize windings during assembly and direct coolant or pumped media during operation.

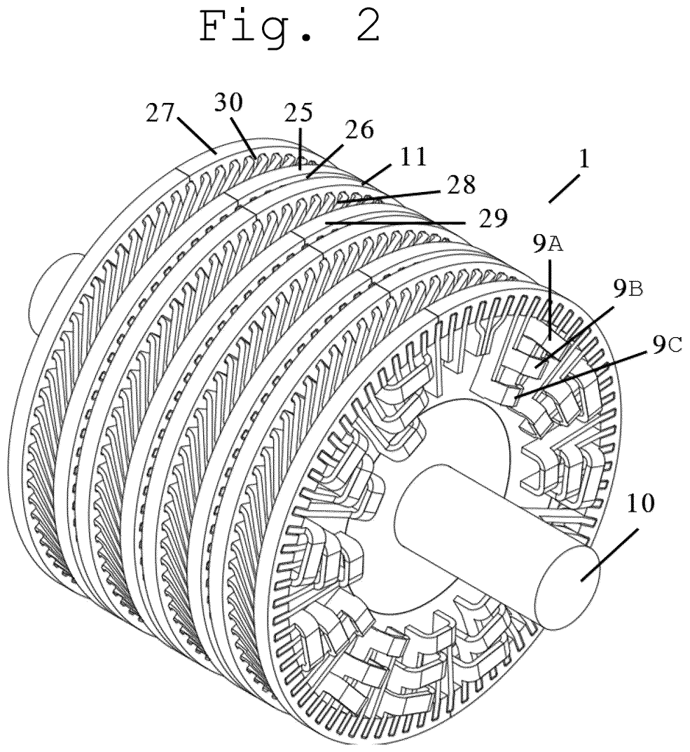

FIG. 2 Winding segments are circularly arrayed about the central axis of axial flux machine 1 in a 360-degree fashion. In this embodiment segments are connected in a typical 3-phase arrangement with separate phases interconnections kept on a separate circumferential plane in relation to the axis and shaft 10 for ease of interconnecting and troubleshooting although alternate winding connections are possible due to all the winding segments interconnections or bridges 9A, 9B, 9C, respectively, outside of the flux path and are easily reconfigured by removing end-bells or bearing supports (not shown). In the gap between two example spacers 11,25 is an example of media entrance area into machine windings 26 (casing, bearings and supports removed for clarity) and an exit area(s) 28 and 3O, formed in the gap between example spacers 11, 29 and spacers 25,27 respectively, for the media fed into area 26 after it has flowed between windings depicted, into an area close to central shaft and exiting between windings and rotor(s) on either side of spacer 25 and spacer 11 not facing gap 26. Example spacers may be made as a single part or part of the case (not shown) or joined in groups or even a single piece if desired or done away with in alternative embodiments.

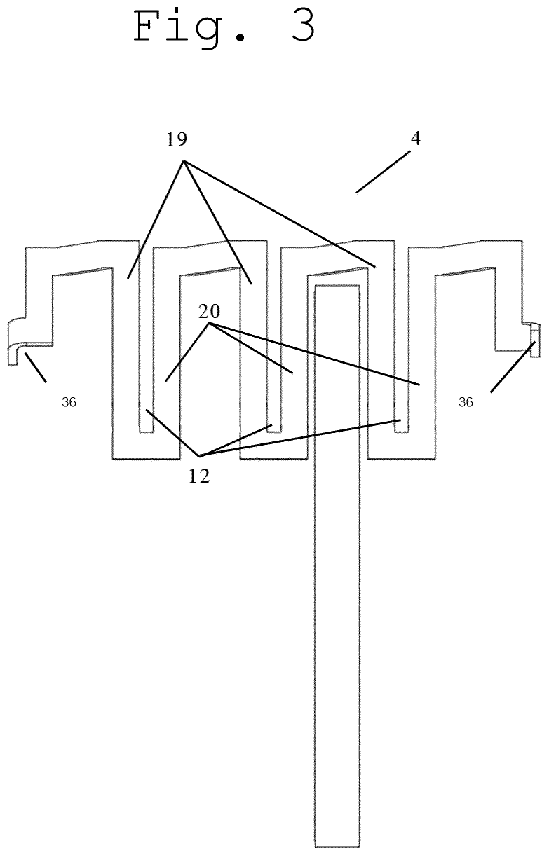

FIG. 3 typical winding segments such as winding 4, from FIG. 1, have gap(s) formed 12 for coolant or pumping media to flow from the exterior area to the inner area of the windings. Depicted are asymmetrical end connections 36 for a single phase. Each winding segment has portions that lie between two rotors and each of these portions have two legs, leg A 19 and leg B 20 although flat windings are shown windings can be flat, round, hollow, twisted wire, litz wire or any other shape conductor.

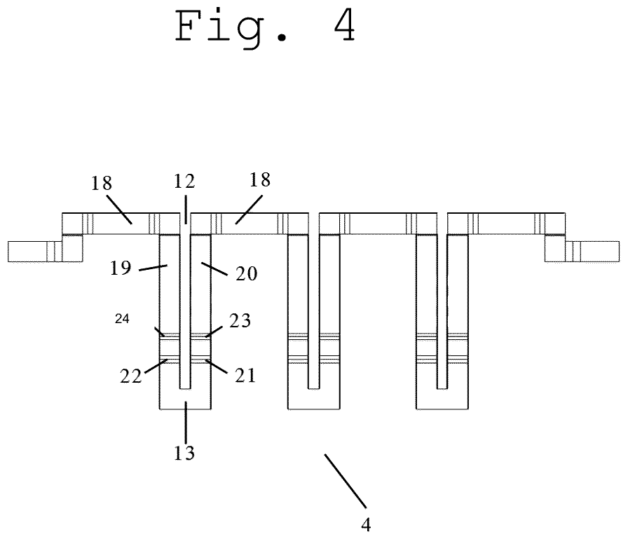

Flat diagram FIG. 4 depict a typical winding segment of a particular phase's bends that allow two legs depicted 19,20 with 19 being leg A and 20 being leg B. Bends are depicted here as 21, 22, 23, 24, which are only indicated on one portion of the typical winding segment 4. Each winding portion has an outer axial cross piece(s) 18 and an inner axial cross piece 13 with 18 extending axially across a rotor and 13 extending axially between two rotors. Other configurations and bends are possible.

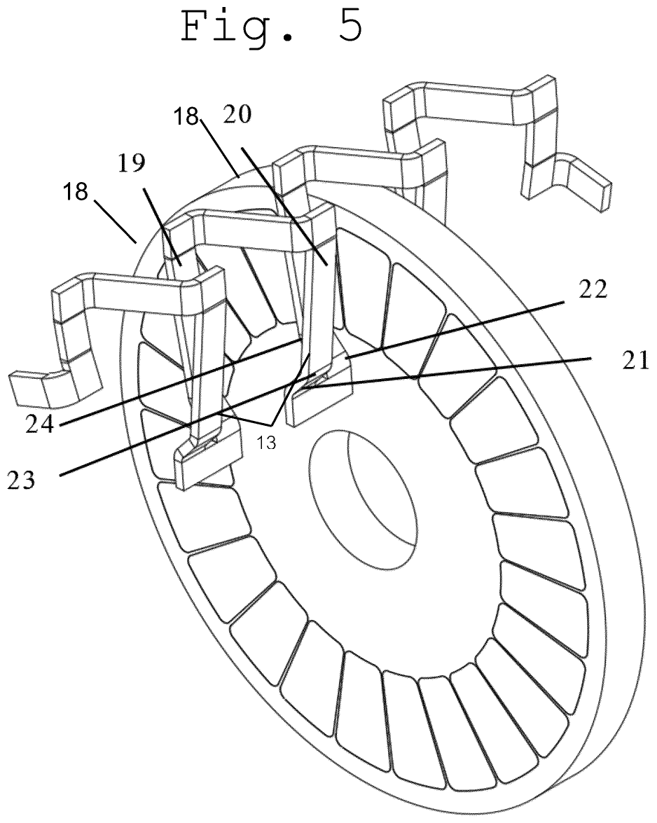

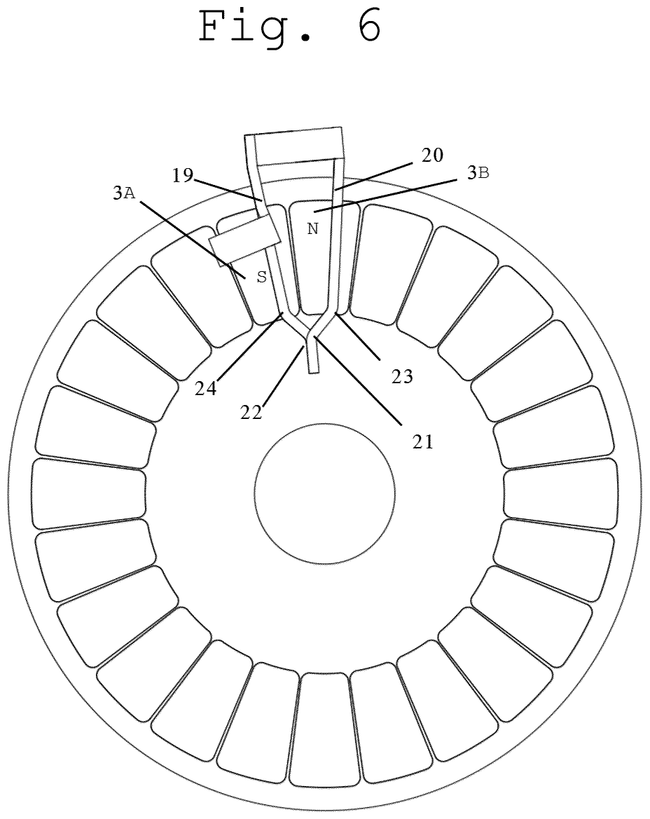

FIG. 5 and FIG. 6 Perspective and axial or end views view of typical bends needed for Leg A 19 and Leg B 20 to cross magnetic flux paths when current is flowing through the winding. Bend 22, is formed to allow leg A 19 to cross a magnetic flux path of a one direction 3A and bends 21, 23 are formed to allow leg B 20 to cross a flux magnetic path of the opposite direction 3B so when current flows down one leg and back up the other force is generated upon the rotor in a common direction. Also shown are cross pieces 18 and 13.

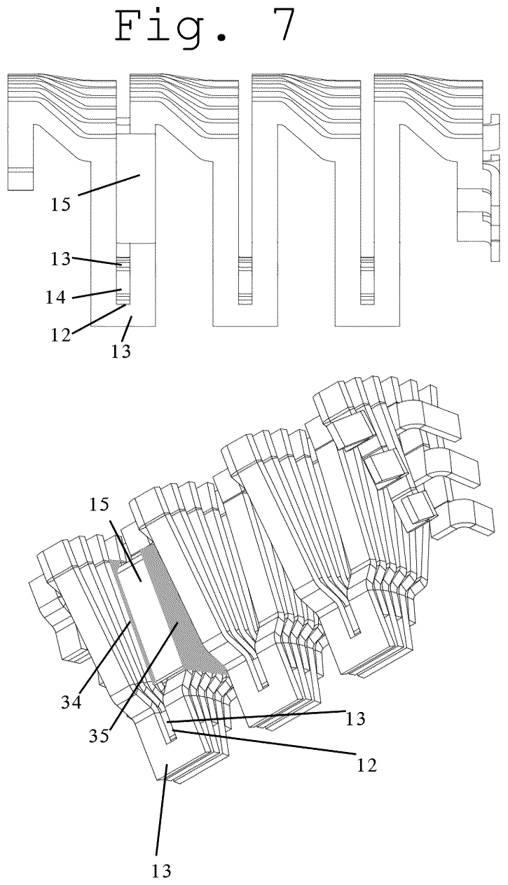

FIG. 7 depicts 6 winding segments connected in pairs of 2 typical of a 3-phase arrangement in normal and perspective view. Shown is said gap 12 and axial cross pieces 13. Between two adjacent windings piece 13 a gap or space 14 may be formed, if needed, by extending other winding(s) length to allow media to flow when windings are extremely tightly packed. Depicted are flux enhancers or core material 15 preferably made of electrical steel, Ferrite, or some other soft magnetic material that can be used to increase the flux density and magnetic attraction between rotors and direct media flow between adjacent windings. Between each leg A and leg B epoxy 34 (shaded area) or some other glue-like material may be used between winding legs and flux enhancers to secure them in place. While epoxy, fiberglass, phenolic paper, or other suitable surface 34 providing definition to media path between the windings, rotor(s), and gap 12

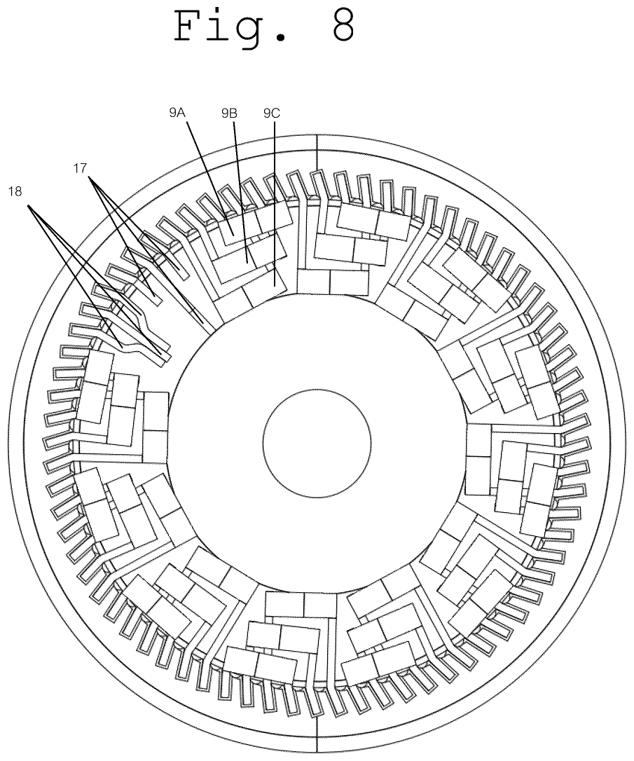

FIG. 8 depicts winding interconnections for a typical 3 phase segment interconnects, 9A, 9B, 9C and a typical Y phase connection between the three phases 18 and external connections 17 from one axial end of said machine.

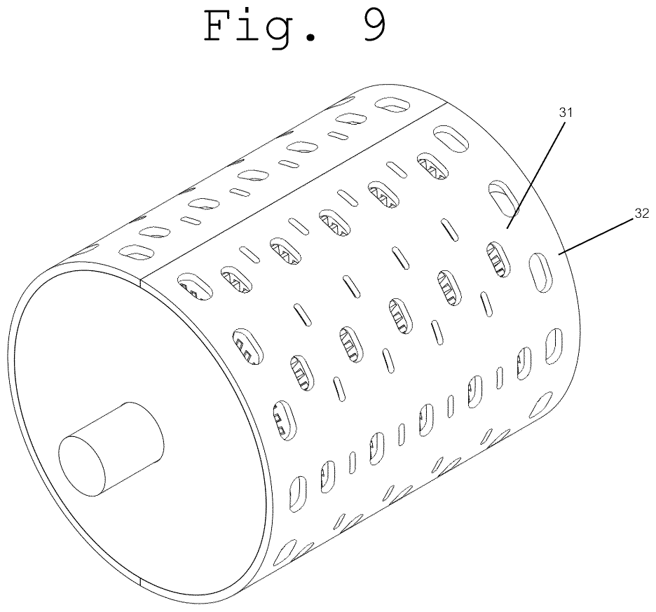

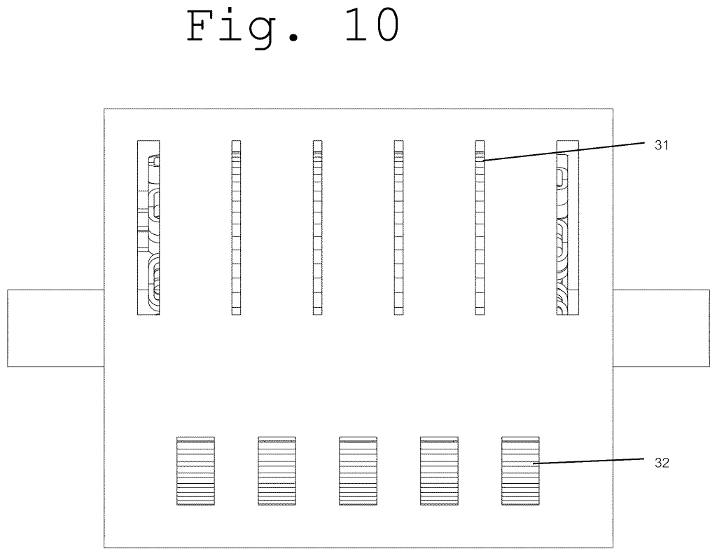

FIGS. 9 and 10 show examples of case entrance and exit openings for coolant or pumped media to flow. Openings may be arranged so that all entrances are on one portion of the case and all exits on another or arrayed around the case as depicted in examples case 8 openings 31, 32 or in arrangements such as 9 for convenience of mounting manifolds, outer coolant case, or partial submersion of said machine into media or coolant.

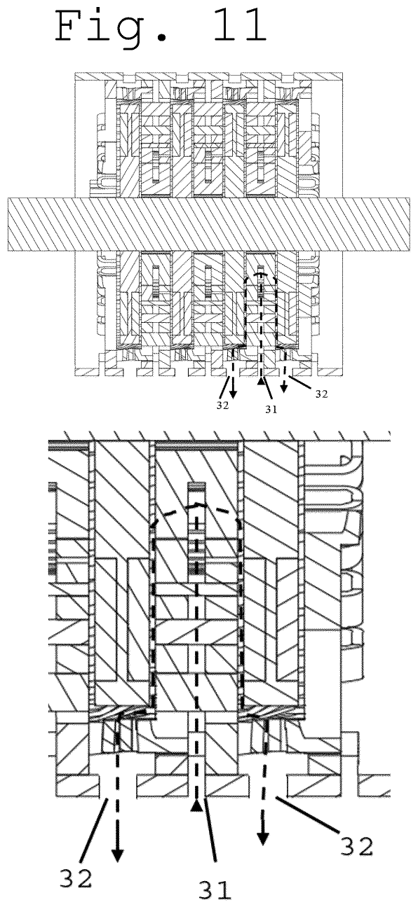

FIG. 11 depicts a cross section of machine depicting a single media path flowing 33 as a dotted line from outside of machine opening case 31 down through windings and returning between windings and rotors before exiting case through openings 32.

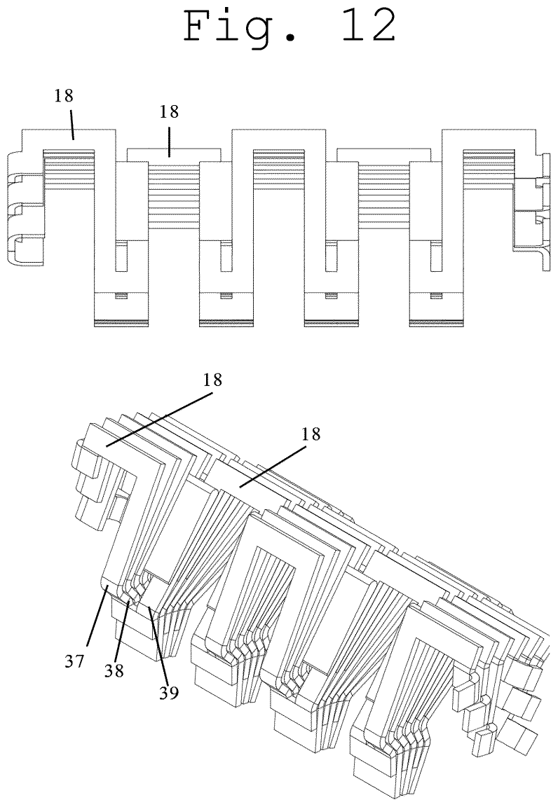

FIG. 12 depicts an alternate winding in normal and perspective views that may be used for rotors with Halbach arrays instead of conventional permanent magnet arrangements with the main difference being 18 now being generally straight and the change in bends depicted as 37, 38 and 39.

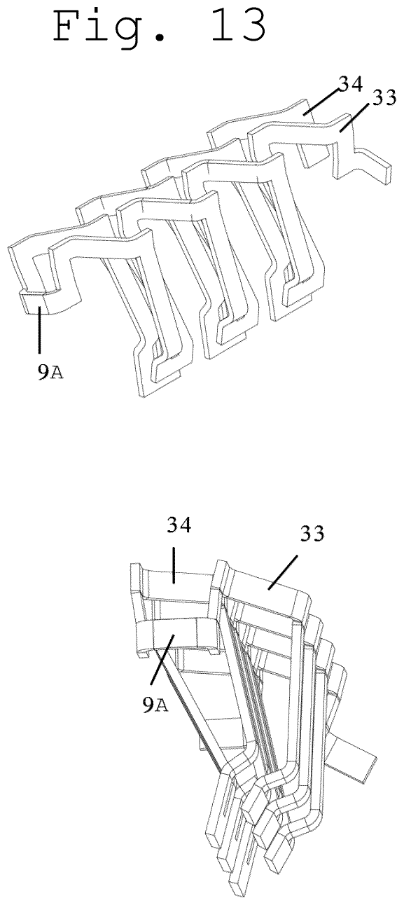

FIG. 13 depicts a typical single winding consisting of two connected segments 33, 34 showing bridge or interconnector 9A to better show multiple segment electrical path

The disclosed devices and methods is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method of use, except as may be outlined in the claims.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific devices and methods described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The devices and/or methods of use disclosed and claimed herein can be made and executed without undue experimentation in light of the present disclosure. While the devices and methods of this invention have been described in terms of preferred embodiments, it will be apparent to those skilled in the art that variations may be applied to the devices and/or methods in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. An axial radial flux motor combination with axial windings as herein disclosed.
